(19) United States
(12) Patent Application Publication
(10) Pub. No.: US 2026/0157832 A1
(43) Pub. Date: Jun. 11, 2026

(54) ORAL IRRIGATOR

(71) Applicant: Thumbs Up Innovations Technology Co., Ltd., Zhuhai (CN)

(72) Inventors: JIACHENG HUANG, Zhuhai (CN); LILIN XU, Zhuhai (CN); XIU ZOU, Zhuhai (CN)

(21) Appl. No.: 18/989,070

(22) Filed: Dec. 20, 2024

(30) Foreign Application Priority Data
Dec. 11, 2024 (CN) 202423067033.6

(51) Int. Cl. A61C 17/02

(52) U.S. Cl. CPC A61C 17/0202

(57) ABSTRACT

An oral irrigator includes an oral irrigator main body, a water tank, and a nozzle. The nozzle is arranged on the oral irrigator main body. The oral irrigator main body is arranged on the water tank. The water tank is provided with a visual window, through which a position of liquid in the water tank is observed. The water tank is internally provided with a fixed water flow channel. The water flow channel is adjacent to or abuts against an inner wall of the water tank. The water flow channel is positioned beside the visual window. The water flow channel is in communication with the nozzle through the oral irrigator main body, and the water flow channel is in communication with a water storage tank of the water tank. By arranging the water flow channel beside the visible window, the water flow channel is hidden and will not be observed.

### CROSS-REFERENCE TO RELATED APPLICATIONS

The application claims priority of Chinese patent application 2024230670336, filed on Dec. 11, 2024, which is incorporated herein by reference in its entireties.

### TECHNICAL FIELD

The present invention relates to an oral irrigator applied in the technical field of oral cleaning.

### BACKGROUND ART

As a type of oral cleaning tool, oral irrigators mainly use the impact of water flow to clean teeth and interdental gaps, and can achieve effective cleaning especially for the interdental gaps. Therefore, oral irrigators are particularly favored by people. In order to achieve better cleaning effects and ensure oral safety, existing oral irrigators are generally used in conjunction with oral cleaning solutions.

An oral irrigator uses high-pressure pulse water generated by a water pump to flush the oral cavity, in order to remove small food residues and harmful bacteria adhering to teeth or gums. However, current oral irrigators are mainly provided with a soft rubber conduit which is directly connected in the middle of an oral irrigator main body and leads to a water tank to suck water. Such a way that the soft rubber conduit directly leads from the middle of the oral irrigator main body down to the inside of the water tank affects the visual esthetics. When the water tank is removed, the soft rubber conduit sways around, making it easy for objects or other liquids on a mouthwash table to touch the soft rubber conduit, causing dirt. When observing a position of the liquid inside the water tank from a visual window, the soft rubber conduit can be seen, which is very unsightly.

For another type of oral irrigator, a body of the oral irrigator is directly designed into a large cylinder and is inserted into a water tank to suck water. Due to the large volume of the part inserted into the water tank, this type of method seriously affects the water storage capacity of the water tank. Due to the humid environment of the water tank, the body of the oral irrigator is prone to mold and bacterial growth when placed in the damp environment of the water tank for a long time.

### SUMMARY

In order to solve the problem that when observing a position of liquid in a water tank from a visual window of oral irrigators in the prior art mentioned above, a soft rubber conduit can be seen resulting in an unsightly appearance, an oral irrigator is provided in the present invention. A water flow channel is fixedly arranged beside a visual window, that is, the water flow channel is hidden, and a user can not observe the water flow channel, making an appearance of the oral irrigator cleaner and more tidy.

The technical solution adopted by the present invention to solve its technical problem is as follows. An oral irrigator is provided in the present invention. The oral irrigator includes an oral irrigator main body, a water tank, and a nozzle. The nozzle is arranged on the oral irrigator main body. The oral irrigator main body is arranged on the water tank. The water tank is provided with a visual window, through which a position of liquid in the water tank is observed. The water tank is internally provided with a fixed water flow channel. The water flow channel is adjacent to or abuts against an inner wall of the water tank. The water flow channel is positioned beside the visual window. The water flow channel is in communication with the nozzle through the oral irrigator main body, and the water flow channel is in communication with a water storage tank of the water tank.

Furthermore, the oral irrigator main body is detachably arranged on the water tank.

Furthermore, the water flow channel includes a first section and a second section. The first section is in communication with the second section. The first section is arranged along a side wall of the water tank. The second section is arranged along a bottom wall of the water tank and is arranged on an outer side of the bottom wall of the water tank. The second section is in communication with the water storage tank of the water tank.

Furthermore, the oral irrigator further includes a column. The water flow channel is provided on the column. The column is positioned near an inner wall of the water tank.

Furthermore, the column includes a column main body and a cover sheet. The column main body is provided with a first flow channel along an extension direction of the column main body. The cover sheet is configured for covering the first flow channel to form the first section.

Furthermore, the oral irrigator further includes a flow channel bottom cover. The flow channel bottom cover is provided with a second flow channel. The flow channel bottom cover is installed on a bottom wall of the water tank, and the flow channel bottom cover is configured for covering the second flow channel, thus forming the second section.

Furthermore, the flow channel bottom cover is provided on an outer side surface of a bottom wall of the water tank. The bottom wall of the water tank is provided with a first mounting hole and a water flow through hole. One end of the column is installed in the first mounting hole and is in communication with the second section. The water flow through hole is in communication with the second section and a water storage chamber of the water tank.

Furthermore, the column includes a longitudinal column and a transverse column. The longitudinal column and the transverse column are connected to form a capital “L” shape. The water flow channel runs through the longitudinal column and the transverse column. An opening of the water flow channel, through which water flows towards the oral irrigator main body, is positioned in the transverse column.

Furthermore, the oral irrigator further includes a first sealing ring. The first sealing ring includes a first waterproof ring main body and two mounting feet. The two mounting feet are arranged on the first waterproof ring main body. The two mounting feet are arranged opposite to each other. Second mounting holes corresponding to the two mounting feet are defined in a side wall of the water flow channel. The second mounting holes are positioned in an opening through which water flows towards the oral irrigator main body. The mounting feet are installed in the second mounting holes through interference fit, so that the first waterproof ring main body is capable of being fixedly installed in the opening of the water flow channel.

Furthermore, a third mounting hole is defined in the longitudinal column for installation of a bolt, so that the column is capable of being fixedly installed on the water tank.

Furthermore, the visual window includes a front observation window unit and a rear observation window unit. The front observation window unit and the rear observation window unit are respectively arranged on a front side and a rear side of the water tank.

Furthermore, the oral irrigator main body includes an outer shell, a control board, and a pumping component. The control board and the pumping component are both disposed inside the outer shell. The pumping component is electrically connected to the control board. A water outlet end of the pumping component is connected to the nozzle. A water inlet end of the pumping component is connected to the water flow channel through an opening defined in the oral irrigator main body.

Furthermore, the oral irrigator further includes a liquid injection cover. A liquid injection opening is defined in the water tank and is in communication with a water storage chamber of the water tank. The liquid injection cover detachably covers the liquid injection opening.

Furthermore, the oral irrigator further includes a second sealing ring. A protruding sealing block is provided on one side of the liquid injection cover facing the water tank. The sealing block is provided with a sealing groove. The second sealing ring is inserted into the sealing groove. An outer surface of the second sealing ring abuts against an edge of the liquid injection opening.

Furthermore, the water tank is inwardly recessed near the liquid injection opening to form an accommodating groove. When the liquid injection cover covers the liquid injection opening, the liquid injection cover is basically accommodated in the accommodating groove.

Furthermore, the liquid injection cover is provided with a first buckle near the sealing block. A second buckle is provided at an edge of the liquid injection opening. The first buckle is clamped to the second buckle.

Furthermore, the oral irrigator further includes a bottom shell. The bottom shell is detachably connected to a bottom portion of the water tank. The bottom shell is provided with a semi-cylindrical capsule accommodating chamber. The capsule accommodating chamber is used for allowing an oral cleaning solution capsule of the oral irrigator to be inserted for use. The bottom portion of the water tank is provided with a liquid outlet opening in communication with the capsule accommodating chamber. The liquid outlet opening is used for allowing a liquid outlet end of the oral cleaning solution capsule of the oral irrigator to be installed.

Furthermore, an upper surface of the bottom shell protrudes upward at a position near the liquid outlet opening to form a protruding portion. The liquid outlet opening is defined in a top portion of the protruding portion.

Furthermore, the protruding portion is conical.

Furthermore, a friction grip portion is provided on an outer side surface of the oral irrigator main body. The friction grip portion is equipped with friction patterns.

Furthermore, a mounting seat is provided on an outer side surface of a bottom portion of the oral irrigator main body. A mounting opening is defined in a top portion of the water tank. The mounting seat is detachably screwed into the mounting opening.

Beneficial effects of the present invention are as follows. The oral irrigator is provided in the present invention. The water flow channel is arranged beside the visual window, that is, the water flow channel is hidden, and the user can not observe the water flow channel. Moreover, the water flow channel is fixedly close to or abuts against the inner wall of the water tank, and the water flow channel is always positioned inside the water tank, so that after the water tank is removed from the oral irrigator main body, the water flow channel will be free from secondary pollution.

### BRIEF DESCRIPTION OF THE DRAWINGS

Implementations of the present disclosure will now be described, by way of embodiment, with reference to the attached figures. It should be understood, the drawings are shown for illustrative purpose only, for ordinary person skilled in the art, other drawings obtained from these drawings without paying creative labor by an ordinary person skilled in the art should be within scope of the present disclosure.

FIG. 1 is a perspective view of an oral irrigator according to the present invention.

FIG. 2 is an exploded view of an oral irrigator according to the present invention.

FIG. 3 is a cross-sectional view of a water flow channel according to the present invention.

FIG. 4 is a schematic diagram of an installation structure of a column and a flow channel bottom cover according to the present invention.

FIG. 5 is a schematic diagram of a structure of a column according to the present invention.

FIG. 6 is a schematic diagram of a structure of a column and a water tank according to the present invention.

FIG. 7 is a cross-sectional view of an oral irrigator according to the present invention.

FIG. 8 is an exploded view from another angle of view of FIG. 2 according to the present invention.

FIG. 9 is a schematic diagram of designing positions of second mounting holes according to the present invention.

### DETAILED DESCRIPTION OF THE EMBODIMENTS

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

The term “comprising” when utilized, means “including, but not necessarily limited to”; it specifically indicates open-ended inclusion or membership in the so-described combination, group, series, and the like. The disclosure is illustrated by way of example and not by way of limitation in the figures of the accompanying drawings in which like references indicate similar elements. It should be noted that references to “an” or “one” embodiment in this disclosure are not necessarily to the same embodiment, and such references can mean “at least one”. In addition, the terms “first” and “second” are used for descriptive purposes only and cannot be understood as indicating or implying relative importance or implying the number of indicated technical features. Thus, the features defined as “first” and “second” may explicitly or implicitly include one or more of the features. In the description of embodiments of the application, “a plurality of” means two or more, unless otherwise specifically defined.

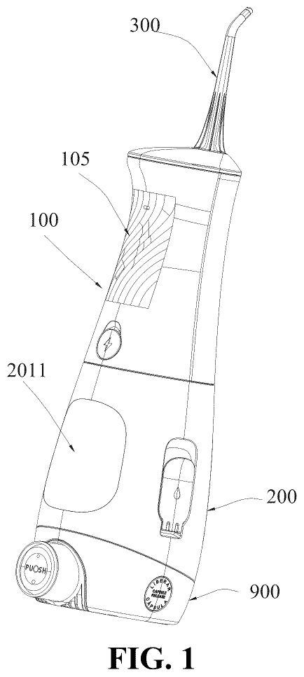

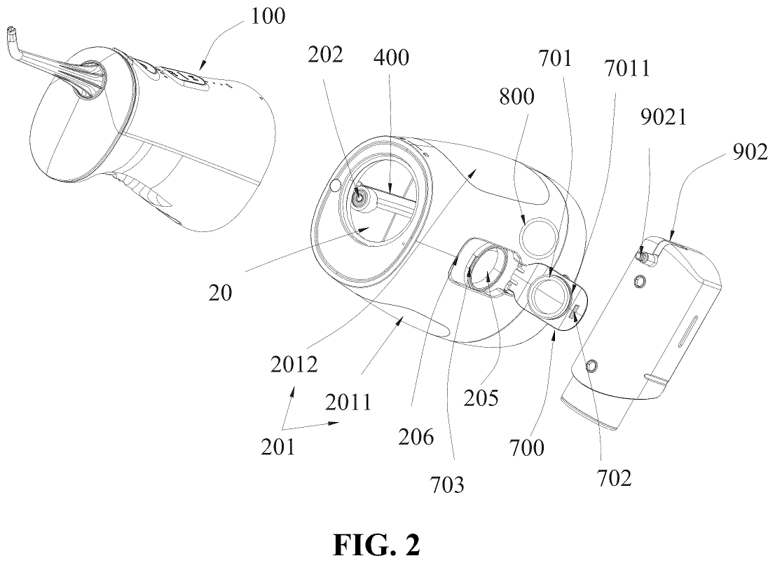

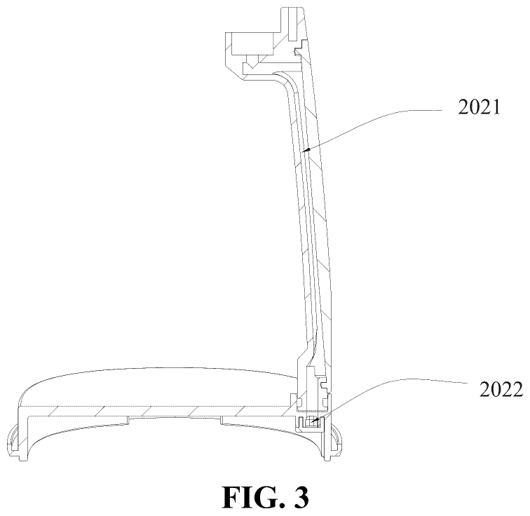

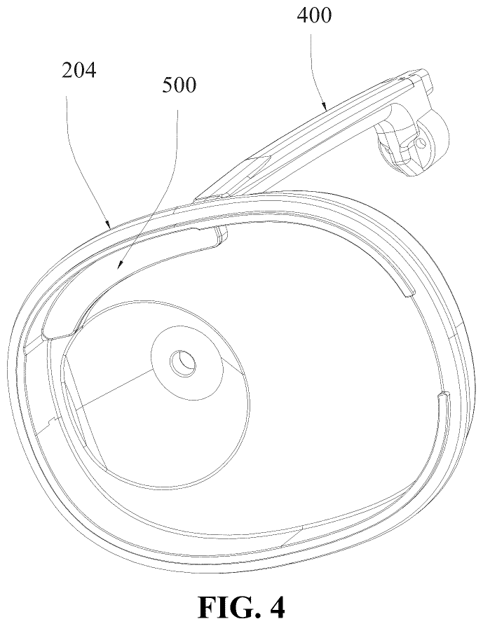

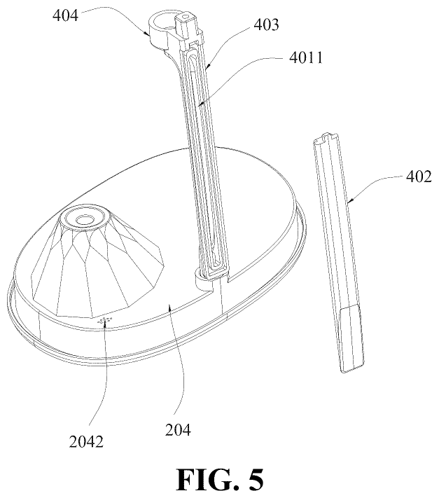

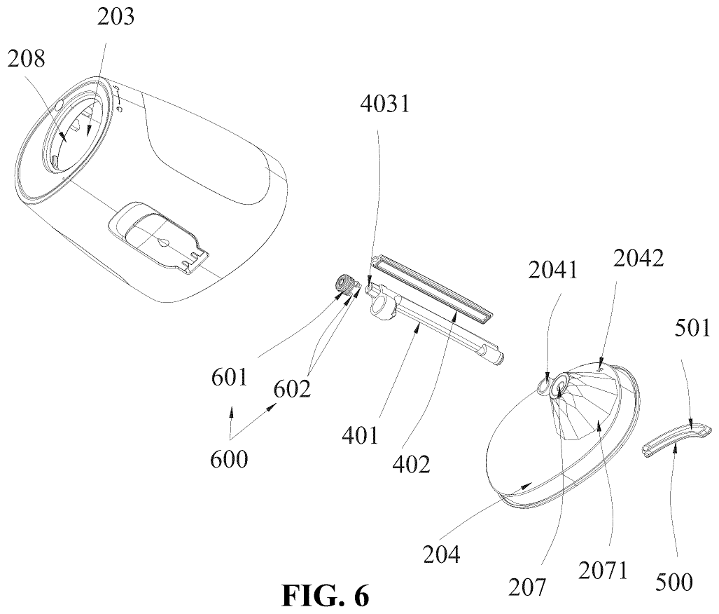

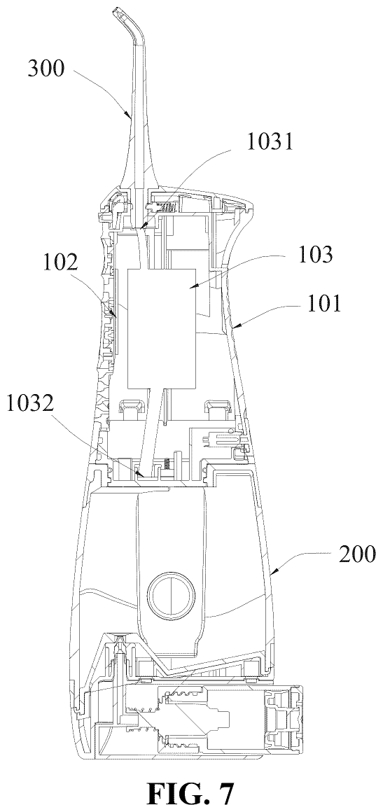

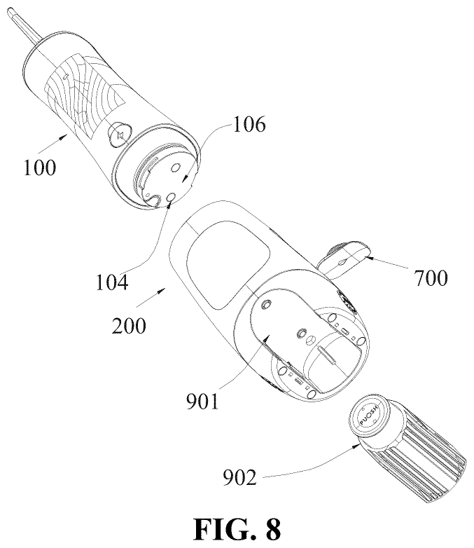

Referring to FIGS. 1-9, an oral irrigator is provided in the present invention. The oral irrigator includes an oral irrigator main body 100, a water tank 200, and a nozzle 300. The nozzle 300 is arranged on the oral irrigator main body 100. The oral irrigator main body 100 is arranged on the water tank 200. The water tank 200 is provided with a visual window 201, through which a position of liquid in the water tank 200 is observed. The water tank 200 is internally provided with a fixed water flow channel 202. The water flow channel 202 is adjacent to or abuts against an inner wall of the water tank 200. The water flow channel 202 is positioned beside the visual window 201. The water flow channel 202 is in communication with the nozzle 300 through the oral irrigator main body 100, and the water flow channel 202 is in communication with a water storage tank of the water tank 200. That is to say, by arranging the water flow channel beside the visible window, the water flow channel in the water tank is hidden, and a user can not observe the water flow channel, making an overall appearance of the oral irrigator more beautiful and tidy. Preferably, the oral irrigator main body 100 is detachably arranged on the water tank 200. Since in the prior art, a soft rubber conduit shakes around, and objects or other liquids on a mouthwash table are easy to touch the soft rubber conduit, causing dirt and stains. For an existing oral irrigator, a body is directly designed as a large cylinder inserted into a water tank to suck water, and the body is placed in a humid environment of the water tank for a long time, so that it is easy to mold and breed bacteria. However, the water flow channel is fixedly close to or abuts against the inner wall of the water tank, and the water flow channel of the water tank is always positioned inside the water tank, so that after the water tank is removed from the oral irrigator main body, the water flow channel is not easily touched by an external component to cause secondary pollution. It should be noted that the formation of the water flow channel can be a hollow column, a rubber tube, or a solid structure such as a water flow channel directly provided on a side wall of the water tank.

In this embodiment, the water flow channel 202 includes a first section 2021 and a second section 2022. The first section 2021 is in communication with the second section 2022. The first section 2021 is arranged along a side wall 203 of the water tank 200. The second section 2022 is arranged along a bottom wall 204 of the water tank 200 and is arranged on an outer side of the bottom wall 204 of the water tank 200. The second section 2022 is in communication with the water storage tank of the water tank 200. Preferably, the second section 2022 is arranged on the outer side of the bottom wall 204 of the water tank 200, so that the liquid in the water tank can be used cleanly, avoiding pollution to the water tank caused by the user forgetting to pour out the liquid in the water tank and the liquid staying in the water tank for too long.

In this embodiment, the oral irrigator further includes a column 400. The water flow channel 202 is provided on the column 400. The column 400 is positioned near an inner wall of the water tank 200. The column 400 is provided to make the flow of the water flow channel smoother. It is convenient to install the column in the water tank. When the oral irrigator main body is installed on the water tank, an opening of the water flow channel in the column is more easily aligned with an opening of a main body of the water tank.

In this embodiment, the column 400 includes a column main body 401 and a cover sheet 402. The column main body 401 is provided with a first flow channel 4011 along an extension direction of the column main body 401. The cover sheet 402 is configured for covering the first flow channel 4011 to form the first section 2021. The structure is simple and easy to assemble and arrange. Moreover, the column main body 401 and the cover sheet 402 can be fixedly installed or detachably arranged. The fixed installation can be achieved through ultrasonic welding, while the detachable arrangement requires attention to the need to seal a gap, making the flow of water in the water flow channel smoother. Ultrasonic welding is preferred between the column main body 401 and the cover sheet 402.

In this embodiment, the oral irrigator further includes a flow channel bottom cover 500. The flow channel bottom cover 500 is provided with a second flow channel 501. The flow channel bottom cover 500 is installed on a bottom wall of the water tank 200. The flow channel bottom cover 500 is configured for covering the second flow channel 501, thus forming the second section 2022. The installation of the flow channel bottom cover 500 can form the second section 2022. The structure and the process are simple.

In this embodiment, the flow channel bottom cover 500 is provided on an outer side surface of a bottom wall of the water tank 200. The bottom wall of the water tank 200 is provided with a first mounting hole 2041 and a water flow through hole 2042. One end of the column 400 is installed in the first mounting hole 2041 and is in communication with the second section 2022. The water flow through hole 2042 is in communication with the second section 2022 and a water storage chamber 20 of the water tank 200. In this way, the liquid in the water tank can be used cleanly, avoiding pollution to the water tank caused by the user forgetting to pour out the liquid in the water tank and the liquid staying in the water tank for too long.

In this embodiment, the column 400 includes a longitudinal column 403 and a transverse column 404. The longitudinal column 403 and the transverse column 404 are connected to form a capital “L” shape. The water flow channel 202 runs through the longitudinal column 403 and the transverse column 404. An opening 2023 of the water flow channel 202, through which water flows towards the oral irrigator main body 100, is positioned on the transverse column 404. The design of this structure increases the service life of the column, because the L-shaped design is more stable than using a single longitudinal column. A single longitudinal column is prone to shaking and damage, and is not easily fixed. The L-shaped surface area is larger, and a size of the opening 2023 of the water flow channel 202, through which water flows towards the oral irrigator main body 100, can be arbitrarily changed.

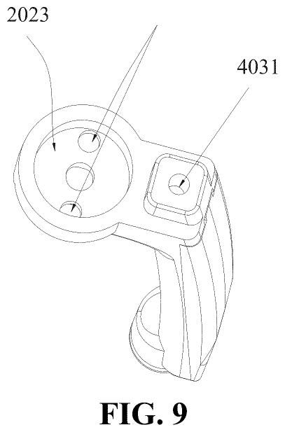

In this embodiment, the oral irrigator further includes a first sealing ring 600. The first sealing ring 600 includes a first waterproof ring main body 601 and two mounting feet 602. The two mounting feet 602 are arranged on the first waterproof ring main body 601, and the two mounting feet 602 are arranged opposite to each other. Second mounting holes 6021 corresponding to the two mounting feet 602 are defined in a side wall of the water flow channel 202. The second mounting holes 6021 are positioned in an opening 2023 through which water flows towards the oral irrigator main body 100. The design of the second mounting holes 6021 are shown in FIG. 9. The mounting feet 602 are installed in the second mounting holes 6021 through interference fit, so that the first waterproof ring main body 601 is capable of being fixedly installed in the opening 2023 of the water flow channel 202, facilitating the sealing of the opening 2023 of the water flow channel 202. The two mounting feet 602 are arranged to make the installation of a main body of the sealing ring more stable, and the sealing ring will not fall off after the water tank is removed from the oral irrigator, thereby avoiding pollution to the water flow channel caused by pollution of the sealing ring.

In this embodiment, a third mounting hole 4031 is defined in the longitudinal column 403 for installation of a bolt, so that the column 400 is capable of being fixedly installed on the water tank 200. Preferably, the third mounting hole is defined in one end near a main body of the water tank, which facilitates the fixed installation of the column and the hidden design of the bolt.

In this embodiment, the visual window 201 includes a front observation window unit 2011 and a rear observation window unit 2012. The front observation window unit 2011 and the rear observation window unit 2012 are respectively arranged on a front side and a rear side of the water tank 200, allowing the user to observe a position of a liquid level in the water storage chamber 20 on both the front side and the rear side of the product, which is convenient for the user to use. Moreover, an appearance of the product is also more beautiful. Preferably, the front observation window unit 2011 is approximately a trapezoid with four rounded corners, and the rear observation window unit 2012 is approximately a trapezoid with four rounded corners. A ratio of an area of the front observation window unit 2011 to an area of the rear observation window unit 2012 is about 1.2-1.8, and the front observation window unit 2011 and the rear observation window unit 2012 are arranged relative to each other.

In this embodiment, the oral irrigator main body 100 includes an outer shell 101, a control board 102, and a pumping component 103. The control board 102 and the pumping component 103 are both disposed inside the outer shell 101. The pumping component 103 is electrically connected to the control board 102. A water outlet end 1031 of the pumping component 103 is connected to the nozzle 300. A water inlet end 1032 of the pumping component 103 is connected to the water flow channel 202 through an opening 104 defined in the oral irrigator main body 100. That is, components that need to be used are all disposed inside the outer shell to form the oral irrigator main body. A control button can also be provided on the oral irrigator main body, such as a control button for turning on and off the water pump, or a control button for adjusting the water flow. The control button is connected to the control board. That is, all circuits and operating components are integrated on the main body of the oral irrigator, and the structure is clear and concise, making it easy to install and maintain the oral irrigator.

In this embodiment, the oral irrigator further includes a liquid injection cover 700. A liquid injection opening 205 is defined in the water tank 200 and is in communication with the water storage chamber 20 of the water tank 200. The liquid injection cover 700 detachably covers the liquid injection opening 205. By arranging the above structure, after the liquid injection cover 700 is opened, water can be injected into the water storage chamber 20 through the liquid injection opening 205, making it convenient for the user to add water at any time. When in use, the liquid injection cover 700 covers the liquid injection opening 205 to prevent water from flowing out and improve the sealing of the product.

In this embodiment, the oral irrigator further includes a second sealing ring 800. A protruding sealing block 701 is provided on one side of the liquid injection cover 700 facing the water tank 200. The sealing block 701 is provided with a sealing groove 7011. The second sealing ring 800 is inserted into the sealing groove 7011. An outer surface of the second sealing ring 800 abuts against an edge of the liquid injection opening 205.

In this embodiment, the water tank 200 is inwardly recessed near the liquid injection opening 205 to form an accommodating groove 206. When the liquid injection cover 700 covers the liquid injection opening 205, the liquid injection cover 700 is basically accommodated in the accommodating groove 206. By arranging the above structure, when the liquid injection cover 700 covers the liquid injection opening 205, the outer surface of the second sealing ring 800 abuts against the edge of the liquid injection opening 205, and an inner surface, an upper surface and a lower surface of the second sealing ring 800 abut against the sealing groove 7011, which can further improve a sealing performance between the liquid injection cover 700 and the liquid injection opening 205, and prevent water from flowing out along a gap between the liquid injection cover 700 and the liquid injection opening 205.

In this embodiment, the liquid injection cover 700 is provided with a first buckle 702 near the sealing block 701. A second buckle 703 is provided at an edge of the liquid injection opening 205. The first buckle 702 is clamped to the second buckle 703. Through the arrangement of the above structure, when the liquid injection cover 700 covers the liquid injection opening 205, the first buckle 702 is clamped to the second buckle 703, and then a free end of the liquid injection cover 700 is connected to the water tank to prevent the rotation of the liquid injection cover 700, thereby improving the stability of the product.

In this embodiment, the oral irrigator further includes a bottom shell 900. The bottom shell 900 is detachably connected to a bottom portion of the water tank 200. The bottom shell 900 is provided with a semi-cylindrical capsule accommodating chamber 901. The capsule accommodating chamber 901 is used for allowing an oral cleaning solution capsule 902 of the oral irrigator to be inserted for use. The bottom portion of the water tank 200 is provided with a liquid outlet opening 207 in communication with the capsule accommodating chamber 901. The liquid outlet opening 207 is used for allowing a liquid outlet end 9021 of the oral cleaning solution capsule 902 of the oral irrigator to be installed. Through the arrangement of the above structure, the oral irrigator is usually arranged with a relatively narrow upper portion and a relatively wide lower portion, a diameter of the lower portion is larger, and the capsule accommodating chamber 901 is defined in the bottom shell 900, so that a larger size of the capsule accommodating chamber 901 can be defined, and a larger volume of the oral cleaning solution capsule 902 can be used to extend the product's usage time and reduce the frequency of replacing the oral cleaning solution capsule 902, making it convenient to use. Moreover, by placing the oral cleaning solution capsule 902 inside the bottom shell 900, the user only needs to squeeze the oral cleaning solution capsule 902 with a palm to achieve the injection of oral cleaning solution when using the oral irrigator, providing a good user experience. A ratio of a length to a width of the capsule accommodating chamber 901 is approximately 1.5-2.0. Preferably, the ratio of the length to the width of the capsule accommodating chamber 901 is 1.8, which can accommodate larger oral cleaning solution capsule 902 and provide a moving space inside the bottom shell 900 to accommodate other components. The design is reasonable.

In this embodiment, an upper surface of the bottom shell 900 protrudes upward at a position near the liquid outlet opening 207 to form a protruding portion 2071. The liquid outlet opening 207 is defined in a top portion of the protruding portion 2071. Through the arrangement of the above structure, the liquid outlet opening 207 is defined in the top portion of the protruding portion 2071 to increase a contact area between the oral cleaning solution passing through the liquid outlet opening 207 and the water. The oral cleaning solution quickly diffuses into the water in the water storage chamber 20, making a cleaning effect of the product better and more stable.

In this embodiment, the protruding portion 2071 is conical, similar to an effect of a volcanic eruption, with a strong sense of design.

In this embodiment, a friction grip portion 105 is provided on an outer side surface of the oral irrigator main body 100. The friction grip portion 105 is equipped with friction patterns. Through the arrangement of the above structure, the friction patterns at the friction grip portion 105 can increase a friction coefficient, making it more stable for the user to grip the product and also making an appearance of the product more beautiful.

In this embodiment, a mounting seat 106 is provided on an outer side surface of a bottom portion of the oral irrigator main body 100. A mounting opening 208 is defined in a top portion of the water tank 200. The mounting seat 106 is detachably screwed into the mounting opening 208 through threads, and the structure is simple, making it easy for the user to disassemble.

In summary, the oral irrigator in this embodiment is designed with a hidden water flow channel in the water tank, with one part of the water flow channel arranged along the inner wall of the water tank and another part of the water flow channel arranged inside a bottom cover of the water tank. Therefore, a soft rubber conduit is cancelled, and the problem of a body being directly inserted into the water tank is avoided. Overall, the water flow channel of the water tank is more aesthetically pleasing, and after the water tank is removed, it is less likely to be touched by an external component to cause secondary pollution. Additionally, a mounting position of the oral cleaning solution capsule 902 is also provided, which can be in communication with the water tank, making it easier for the user to squeeze oral cleaning solution into the water tank.

The above description only describes embodiments of the present disclosure, and is not intended to limit the present disclosure; various modifications and changes can be made to the present disclosure. Any modifications, equivalent substitutions, and improvements made within the spirit and scope of the present disclosure are intended to be included within the scope of the present disclosure.

What is claimed is:

1. An oral irrigator, comprising:
an oral irrigator main body;
a water tank; and
a nozzle;
wherein the nozzle is arranged on the oral irrigator main body; the oral irrigator main body is arranged on the water tank; the water tank is provided with a visual window, through which a position of liquid in the water tank is observed; the water tank is internally provided with a fixed water flow channel; the water flow channel is adjacent to or abuts against an inner wall of the water tank; the water flow channel is positioned beside the visual window; the water flow channel is in communication with the nozzle through the oral irrigator main body; and the water flow channel is in communication with a water storage tank of the water tank.

2. The oral irrigator according to claim 1, wherein the oral irrigator main body is detachably arranged on the water tank.

3. The oral irrigator according to claim 1, wherein the water flow channel comprises a first section and a second section; the first section is in communication with the second section; the first section is arranged along a side wall of the water tank; the second section is arranged along a bottom wall of the water tank and is arranged on an outer side of the bottom wall of the water tank; and the second section is in communication with the water storage tank of the water tank.

4. The oral irrigator according to claim 3, further comprising a column, wherein the water flow channel is provided on the column; and the column is positioned near an inner wall of the water tank.

5. The oral irrigator according to claim 4, wherein the column comprises a column main body and a cover sheet; the column main body is provided with a first flow channel along an extension direction of the column main body; and the cover sheet is configured for covering the first flow channel to form the first section.

6. The oral irrigator according to claim 5, further comprising a flow channel bottom cover, wherein the flow channel bottom cover is provided with a second flow channel; the flow channel bottom cover is installed on a bottom wall of the water tank; and the flow channel bottom cover is configured for covering the second flow channel, thus forming the second section.

7. The oral irrigator according to claim 5, wherein the flow channel bottom cover is provided on an outer side surface of a bottom wall of the water tank; the bottom wall of the water tank is provided with a first mounting hole and a water flow through hole; one end of the column is installed in the first mounting hole and is in communication with the second section; and the water flow through hole is in communication with the second section and a water storage chamber of the water tank.

8. The oral irrigator according to claim 4, wherein the column comprises a longitudinal column and a transverse column; the longitudinal column and the transverse column are connected to form a capital “L” shape; the water flow channel runs through the longitudinal column and the transverse column; and an opening of the water flow channel, through which water flows towards the oral irrigator main body, is positioned in the transverse column.

9. The oral irrigator according to claim 4, further comprising a first sealing ring, wherein the first sealing ring comprises a first waterproof ring main body and two mounting feet; the two mounting feet are arranged on the first waterproof ring main body; the two mounting feet are arranged opposite to each other; second mounting holes corresponding to the two mounting feet are defined in a side wall of the water flow channel; the second mounting holes are positioned in an opening through which water flows towards the oral irrigator main body; and the mounting feet are installed in the second mounting holes through interference fit, so that the first waterproof ring main body is capable of being fixedly installed in the opening of the water flow channel.

10. The oral irrigator according to claim 9, wherein a third mounting hole is defined in the longitudinal column for installation of a bolt, so that the column is capable of being fixedly installed on the water tank.

11. The oral irrigator according to claim 1, wherein the visual window comprises a front observation window unit and a rear observation window unit; and the front observation window unit and the rear observation window unit are respectively arranged on a front side and a rear side of the water tank.

12. The oral irrigator according to claim 1, wherein the oral irrigator main body comprises an outer shell, a control board, and a pumping component; the control board and the pumping component are both disposed inside the outer shell; the pumping component is electrically connected to the control board; a water outlet end of the pumping component is connected to the nozzle; and a water inlet end of the pumping component is connected to the water flow channel through an opening defined in the oral irrigator main body.

13. The oral irrigator according to claim 1, further comprising a liquid injection cover, wherein a liquid injection opening is defined in the water tank and is in communication with a water storage chamber of the water tank; and the liquid injection cover detachably covers the liquid injection opening.

14. The oral irrigator according to claim 13, further comprising a second sealing ring, wherein a protruding sealing block is provided on one side of the liquid injection cover facing the water tank; the sealing block is provided with a sealing groove; the second sealing ring is inserted into the sealing groove; and an outer surface of the second sealing ring abuts against an edge of the liquid injection opening.

15. The oral irrigator according to claim 13, wherein the water tank is inwardly recessed near the liquid injection opening to form an accommodating groove; and when the liquid injection cover covers the liquid injection opening, the liquid injection cover is basically accommodated in the accommodating groove.

16. The oral irrigator according to claim 15, wherein the liquid injection cover is provided with a first buckle near the sealing block; a second buckle is provided at an edge of the liquid injection opening; and the first buckle is clamped to the second buckle.

17. The oral irrigator according to claim 1, further comprising a bottom shell, wherein the bottom shell is detachably connected to a bottom portion of the water tank; the bottom shell is provided with a semi-cylindrical capsule accommodating chamber; the capsule accommodating chamber is used for allowing an oral cleaning solution capsule of the oral irrigator to be inserted for use; the bottom portion of the water tank is provided with a liquid outlet opening in communication with the capsule accommodating chamber; and the liquid outlet opening is used for allowing a liquid outlet end of the oral cleaning solution capsule of the oral irrigator to be installed.

18. The oral irrigator according to claim 17, wherein an upper surface of the bottom shell protrudes upward at a position near the liquid outlet opening to form a protruding portion; and the liquid outlet opening is defined in a top portion of the protruding portion.

19. The oral irrigator according to claim 18, wherein the protruding portion is conical.

20. The oral irrigator according to claim 1, wherein a mounting seat is provided on an outer side surface of a bottom portion of the oral irrigator main body; a mounting opening is defined in a top portion of the water tank; and the mounting seat is detachably screwed into the mounting opening.
